(19) United States
(12) Patent Application Publication
(10) Pub. No.: US 2024/0159362 A1
(43) Pub. Date: May 16, 2024

(54) BALLOON GAS TANK FILLING PIECE

(71) Applicant: FOLAT B.V., HAARLEM (NL)

(72) Inventor: Marc MULCKHUYSE, HAARLEM (NL)

(21) Appl. No.: 18/282,434

(22) PCT Filed: Mar. 23, 2022
(86) PCT No.: PCT/EP2022/057634

§ 371 Date: Sep. 15, 2023

(30) Foreign Application Priority Data
Mar. 23, 2021 (NL) 2027812
Feb. 2, 2022 (NL) 2030809

(51) Int. Cl. F17C 13/04

(52) U.S. Cl. CPC F17C 13/04; F17C 2205/0332; F17C 2205/0394; F17C 2221/017; F17C 2223/036; F17C 2260/036

(57) ABSTRACT

Filling piece coupling assembly, e.g. for filling a balloon, configured to be connected to a gas tank including a coupling piece, configured to be fixed to the gas tank and including a circumferential wall, which defines an interior of the coupling piece, wherein the circumferential wall includes a first internal thread and a distinct second internal thread, which are aligned parallel to each other and spaced from each other in an axial direction, a valve, including a hollow cylindrical housing provided with a first outer thread, corresponding to the first internal thread of the coupling piece and a filling piece, separate from the valve, including a second outer thread, which substantially corresponds to the second internal thread of the coupling piece, wherein the second outer thread is configured to cooperate with the second internal thread to releasably connect the filling piece to the coupling piece to form a gas-tight connection.

### FIELD OF THE INVENTION

The present invention relates to a filling piece coupling assembly, e.g. for filling a balloon, a gas tank comprising the coupling piece of the filling piece coupling assembly, a method for coupling a filling piece and a valve to a coupling piece and a method for refilling a gas tank.

### STATE OF THE ART

At present, various types of balloon gas tanks are available that are filled with pressurised balloon gas, such as a helium mixture. As pressure can reach 110 bar, gas tanks can be relatively heavy to withstand the pressure and need relatively expensive operating valves.

Also, balloon gas tanks are available that have a convenient low volume to be used for a single occasion, such as a party. Here, it is advantageous that a convenient and pretty filling piece is provided with which the balloons can be filled with gas from the tank easily. As balloons are usually filled for a festive occasion, one wants to minimise hassle.

EP3368812B1 discloses a simplified filling device for a tank which allows the gas dispensing to be quantized, to block the gas dispensing at the end of use, and which is easy to be manufactured. The device comprises an upper valve (tank valve) and a discharging valve of a moulded plastic material that can be screwed upon the upper valve. The tank valve comprises a hollow body and a shutter extending outwardly from the tank valve. When the discharging valve is mounted on the tank valve, the shutter remains not pressed such that the tank can remain closed. By pressing a lever on the discharging valve, the shutter can be pressed to open the tank valve for filling a balloon.

A disadvantage of the device of EP3368812B1 is that the upper valve, with protruding shutter, is relatively prone to damage by external objects, in particular when the filling piece is detached therefrom. This is problematic as damage potentially results in gas leaks. Further, the outer thread of the valve can be scraped or damaged, which may result in the discharging valve not being able to be screwed thereon any more.

Also, when screwing the filling valve on the tank valve, screwing forces are exerted on the tank valve that potentially cause deformation thereof.

Additionally, it has been found that with use, for example upon multiple usages of the discharging valve, or when the gas tank is almost empty, the valve may not seal adequately such that gas may escape from the gas tank. Also, due to inadequate sealing, pollution may enter the valve and/or the gas tank, which could result in clogging and/or wear of the valve. Pollution in the valve and/or in the tank may prevent reuse thereof.

Mounting the filling valve on the upper valve by screwing may be relatively tedious and a position of the filling valve with respect to the tank can sometimes be inconvenient, in particular if elements as handles or so-called ears are present on the tank.

Further, it has been found that the plastic filling piece is prone to leaks due to movement of the lever during use thereof.

Finally, removing the upper valve for maintenance or replacement is challenging due to its engagement with the tank.

As a result of the disadvantages, the devices of the prior art and EP3368812 in particular are suited for single use but not or limitedly suited for reuse.

### SUMMARY OF THE INVENTION

It is therefore an object of the invention to provide a filling piece coupling assembly for filling a balloon that at least partially overcomes the disadvantages of the prior art, or at least to provide an alternative filling piece coupling assembly, for example a filling piece coupling assembly that is suited for sustainable reuse.

The present invention provides a filling piece coupling assembly, e.g. for filling a balloon, according to the present application. The filling piece coupling assembly is configured to be connected to a gas tank, for example containing pressurized helium gas, and comprises:
a coupling piece, configured to be fixed to the gas tank and comprising a circumferential wall, which defines an interior of the coupling piece, wherein the circumferential wall comprises a first internal thread and a distinct second internal thread, which are aligned parallel to each other and spaced from each other in an axial direction,
a valve, comprising a hollow cylindrical housing provided with a first outer thread, which substantially corresponds to the first internal thread of the coupling piece, and with a shutter that is located in the housing and movable with respect to the housing between a closed position, in which the shutter is engaged with the housing to be substantially gas tight, and an open position, in which the shutter is at least partially positioned at a distance from the housing to allow gas to flow through the valve, wherein the first outer thread is configured to cooperate with the first internal thread to form a gas-tight connection between the coupling piece and the valve, and wherein the valve is located inside the interior of the coupling piece, and
a filling piece, separate from the valve, comprising a hollow body with an inflow opening and an outflow opening, defining a gas passage between the openings, an o, with a movable transfer element, and a second outer thread, which substantially corresponds to the second internal thread of the coupling piece.

The second outer thread is configured to cooperate with the second internal thread to releasably connect the filling piece to the coupling piece, to form a gas-tight connection between the coupling piece and the inflow opening of the filling piece, and
the transfer element is engageable with the shutter of the valve, to transfer an actuation movement of the actuator to the shutter to move the shutter to the open position.

According to the present invention, the valve and the filling piece, e.g. a balloon filling piece, can be coupled with each other via the coupling piece, such that, the transfer element of the filling piece can engage with the shutter of the valve to transfer an actuation movement.

A benefit of the filling piece coupling assembly according to the present invention lies in the fact that the filling piece can releasably be attached to the coupling piece instead of to the valve itself. This has several advantages:

Firstly, forces exerted on the filling piece are guided through the coupling piece instead of through the valve. Forces such as screwing forces when screwing the filling piece on the coupling piece, actuation forces on the actuator during the actuation movement, and forces due to a gas pressure exerted on the gas passage of the filling piece are guided through the coupling piece, and the risk of deformation of the valve is reduced.

Secondly, as the first outer thread of the valve is screwed in the first internal thread of the coupling piece, the valve is at least partially located within the interior space of the coupling piece and is therefore less prone to damage. Further, as the first outer thread is screwed in the internal thread, the first outer thread is protected by the coupling piece.

The valve comprises at least one movable component, namely the shutter.

Therefore, the valve may require more maintenance and/or may be a relatively expensive component compared to the coupling piece. Therefore, protection of the valve by the coupling piece is advantageous.

In the prior art, it is known to protect the valve with handles or so-called ‘ears’ located on an upper part of the gas tank around the valve and, for example, overpressure protection means. These handles or ears usually extend from the gas tank around the valve and overpressure protection means with at least the height of the valve and overpressure protection means. By having a coupling piece, the valve may be protected in the coupling piece and a gas tank without ears, i.e. a gas tank that is lighter and more compact can be obtained. This is especially advantageous when multiple gas tanks are transported. By omitting the handles or ears, a smaller packaging may be provided and a larger number of gas tanks may be shipped within a single container. This may result in a significant two-fold reduction of the environmental footprint of the gas tank during production, transport and usage, in particular in a reduction of CO₂-emissions.

Finally, the coupling piece can be fixed permanently to a gas tank, for example by a weld, whereas the valve remains detachably connectable with the first inner/outer threads for maintenance or replacement. This way, leakage due to a malfunctioning valve, for example due to pollution, may be solved by unscrewing and replacing the valve.

The combination of a coupling piece, a valve and a filling piece in the filling piece coupling assembly according to the present invention at least partially solves the disadvantages of the prior art and may enable convenient actuation for filling balloons with simplified detachable connection of the components and reduced risk of damage. Upon detachment of the filling piece from the coupling piece, the valve may enable refilling of the gas tank. Therewith, sustainable reuse of the filling piece coupling assembly, and of the gas tank in particular, can be achieved.

The coupling assembly is suited for filling a balloon with balloon gas, such as a mixture comprising helium and air.

The valve may be connectable to the coupling piece by screwing the first outer thread of the valve in the first internal thread of the coupling piece and the filling piece may be connected to the coupling piece by screwing the second outer thread of the filling piece in the second internal thread of the coupling piece.

As the first internal thread and the second internal thread are distinct, the valve and the filling piece can be connected to the coupling piece at the same time.

When the valve and the filling piece are connected to the coupling piece, the filling piece and the valve are aligned parallel to each other due to the alignment of the first internal thread and the second internal thread, such that an actuation movement may be transferred to the shutter via the transfer element in the parallel direction.

In use, the shutter may normally be arranged in the closed position due to a gas pressure in the gas tank and/or due to a biasing force from a biasing element, such as a spring, such that the shutter the actuation movement is required to move and/or to hold the shutter in the open position.

In the closed position of the shutter, the hollow body of the filling piece can be at ambient pressure.

The transfer element may be engageable with the shutter by pushing, such that the actuation movement can be a push movement of the actuator towards the shutter of the valve, causing the transfer element to push the shutter away from the housing towards the open position, against the gas pressure in the gas tank and/or the biasing force.

Alternatively, transfer element may engage with the shutter differently, such as by pulling, such that the actuation movement can be a pull movement of the actuator away from the shutter of the valve, causing the transfer element to pull the shutter away from the housing towards the open position, in accordance with the gas pressure in the gas tank and against the biasing force.

The shutter may be provided with an engagement surface facing the transfer element that is engageable with the transfer element. In particular, the engagement surface of the shutter may be provided with a centring structure, such as a groove or recess to avoid slip or deflection of the transfer element on the shutter, or vice versa.

In the open position of the shutter, a gas tank and the outflow opening of the filling piece are fluidly connected via the coupling piece, such that gas can flow out of the tank and through the outflow opening to inflate a balloon.

The second internal thread of the coupling piece may have a length that is larger than a length of the second external thread of the filling piece. This way, screwing of the second external thread in the second internal thread for connecting the filling piece with the coupling piece is not limited by the respective threads. As such, screwing may be limited by contact other surfaces of the coupling piece and the valve and/or the filling piece.

Additionally, screwing the second outer thread in the second internal thread may result in other surfaces of the filling piece and the valve and/or the filling piece to be pressed against each other sufficiently to form a gas-tight connection between respective other outer surfaces.

The coupling piece may comprise a first outer end, wherein the first internal thread extends towards the first outer end of the coupling piece, and a second outer end, wherein the second internal thread extends towards the second outer end of the coupling piece.

The valve may be provided with a first end, wherein the first outer thread extends towards the first end of the valve, and a second end that is opposite to the first end.

In an embodiment, the coupling piece comprises a first sealing surface, that extends from the circumferential wall at least partially in a radial direction, wherein the valve comprises a first contra surface that substantially corresponds to the first sealing surface to be pressed against each other during screwing the first outer thread in the first internal thread to form a gas-tight connection between the coupling piece and the valve. In particular, the first sealing surface may extend from the circumferential wall between the first internal thread and the second internal thread.

Alternatively, the first sealing surface may extend from the circumferential wall nearby an outer end of the first internal thread. This outer end of the first internal thread may be a lower end of the first internal thread, being the end that projects towards the interior of the gas tank upon placement of the filling piece coupling assembly on the gas tank.

In an embodiment, the valve comprises a second sealing surface, that extends at the second end at least partially in a radial direction, wherein the filling piece comprises a second contra surface that substantially corresponds to the second sealing surface to be pressed against each other during screwing the second outer thread in the second internal thread to form a gas-tight connection between the valve and the filling piece. In particular, the second sealing surface may be formed by an outer wall of the housing at the second end of the valve.

In an alternative or additional embodiment, the coupling piece comprises a third sealing surface, that extends from the circumferential wall at least partially in a radial direction, wherein the filling piece comprises a third contra surface that substantially corresponds to the third sealing surface to be pressed against each other during screwing the second outer thread in the second internal thread to form a gas-tight connection between the coupling piece and the filling piece. In particular, the third sealing surface may extend from the circumferential wall at the second outer end of the coupling piece.

When screwing the second outer thread in the second internal thread, the second contra surface may be pushed against the second sealing surface and/or the third contra surface may be pushed against the third sealing surface to form a substantially gas tight connection.

By having a first, second and/or a third sealing surface, respectively first, second and/or a third contra surface, advantageous sealing may be achieved, for example against a gas pressure in the gas tank. Further, with the second sealing surface, the hollow body may engage stably with the valve, and/or with the third sealing surface, the filling piece may be connected stably on the coupling piece.

The coupling piece may also comprise the first and/or third sealing surface on the first outer end and/or on other locations. The valve may also comprise the second sealing surface on other locations. The first, second and/or third sealing surface may be a smooth surface.

The first, second and/or third sealing surface, respectively first, second and/or third contra surface may be provided with a groove for seating a gasket or O-ring to seal the respective sealing surface against the respective contra surface gas-tight with the gasket or the O-ring.

The cylindrical housing end may be provided with a tool coupling, such as a hexagonal socket, at the second outer end with which the valve may be rotated for screwing the first outer thread in the first internal thread. This allows for easy replacement or maintenance of the valve to make reuse thereof easier.

In an embodiment, a first contra surface extends at least partially in a radial direction from the cylindrical housing at the second end. This way, the valve may be connected to the coupling piece by screwing the first outer thread in the first internal thread, whereby the first contra surface is pushed against the first sealing surface to form a gas-tight connection between the valve and the coupling piece.

In an embodiment, the second internal thread and/or the second outer thread comprises a flattened portion that extends in axial direction over a portion of the second internal thread and/or the second outer thread.

By having a flattened portion, the filling piece may be detachably connected to the coupling piece by subsequent insertion of the second outer thread into the flattened portion of the second internal thread, or vice versa, after which the second outer thread is screwed in the second internal thread to form a gas-tight connection between the coupling piece and the inflow opening of the filling piece. This way, the filling piece may be conveniently connected to the coupling piece using less screwing compared to a thread without flattened portion.

In an embodiment, the filling piece comprises a mounting ring that is rotatable with respect to the hollow body, wherein the second outer thread is provided on the mounting ring.

By having a rotatable mounting ring, the second outer thread may be rotated to connect the filling piece to the coupling piece by rotating the mounting ring without rotating the hollow body, such that a position of the outflow opening with respect to the coupling piece may be held constant when screwing the second internal thread into the second outer thread.

Mounting the filling piece on the upper valve by screwing may be relatively tedious and a position of the filling valve with respect to the tank can sometimes be inconvenient, in particular if obstructions are present that obstruct rotation of the entire filling piece. With a rotatably connected mounting ring, only the mounting ring may need to be rotated for screwing the filling piece on the coupling piece.

The mounting ring may be configured to form a connection between the filling piece and the coupling piece. For example, the mounting ring may from the only connection between the filling piece and the coupling piece.

Additionally, the looks of a gas tank may be unattractive for festive occasions. Therefore, the gas tank may be arranged in attractive packaging, such as a cardboard box. The packaging may be provided with a filling piece opening for filling a balloon with the filling piece trough the filling piece opening. This way, a balloon may be filled while the gas tank remains within the packaging. Thereby, the mounting ring may allow rotation of the filling piece to align the filling piece, for example a nozzle thereof, with the filling piece opening of the packaging, without rotating the entire gas tank within the packaging.

Thus, with the mounting ring, an advantageous position of the outflow opening may be selected, for example a position that is not obstructed by packaging of the gas tank.

In a further embodiment, the second sealing surface of the filing piece is arranged on the mounting ring, in particular wherein a side of the mounting ring facing the second outer thread forms the sealing surface.

In a further embodiment, the mounting ring is rotatably connected to the hollow body by means of a form-fit connection. By having a form-fit connection, the mounting ring may be connected to the hollow body while keeping rotational freedom.

For example, an outer area of the hollow body at the inflow opening may comprise an outwardly protruding latch, and an inner area of the mounting ring may comprise an inwardly protruding ridge or vice versa, such that a form-fit connection is formed by the latch of the mounting ring latching behind the ridge of the hollow body, or vice versa.

The mounting ring may be rotatably connected to the hollow body by means of a snap-fit connection. It has been found that a form-fit connection, in particular a snap-fit connection is advantageous to manufacture.

In an embodiment wherein the filling piece comprises a mounting ring, the mounting ring comprises a grip part and threaded part that is distinct from the grip part, wherein the grip part is movably connected to the threaded part via a transmission mechanism to transmit a movement of the grip part to the threaded part via the transmission mechanism. The threaded part is provided with the second outer thread. The movement transmitted with the transmission mechanism may be a rotation movement to rotate the second outer thread. The grip part may be coaxially aligned with the threaded part.

By using a transmission mechanism, a rotation of the grip part may be transferred to the threaded part with a different force and/or displacement, such that the second outer thread may be screwed more conveniently in the second inner thread.

In a further embodiment, the transmission mechanism is switchable between a first state and a second state, wherein, in the first state, the transmission mechanism transmits a movement of the grip part to the threaded part to rotate the second outer thread, and in the second state, the transmission mechanism allows the grip part to move with respect to the threaded part. The transmission mechanism switches from the first state to the second state when a predetermined threshold force is exceeded.

The threshold force may be predetermined by the design of the transfer mechanism and may, for example, be the force required to rotate the second outer thread further into the inner thread when the second contra surface is already pushed against the second sealing surface and/or when the third contra surface is already pushed against the third sealing surface. This way, the transmission mechanism may help to avoid that the second outer thread is screwed too far into the second internal thread, which may potentially cause deformation or damage of the filling piece coupling assembly.

Additionally, the transmission mechanism may help to achieve that the second contra surface is pushed against the second sealing surface and/or that the third contra surface is pushed against the third sealing surface with a relatively constant force upon removal and reconnection of the filling piece.

For example, the grip part may move freely in the second state such that he second outer thread is no longer rotated when rotating the grip part upon exceeding the predetermined threshold force. In an embodiment, the transmission mechanism comprises teeth provided on the threaded part and a ratchet to cooperate with the teeth on the grip part, or vice versa, wherein the ratchet slips along the teeth when the predetermined threshold force is exceeded. This way, an audible click may be produced by the ratchet when slipping along the teeth, such that a user may be informed that the filling piece is coupled to the coupling piece.

In an embodiment, the inflow opening is arranged at a first end of the hollow body,
wherein the outflow opening is, for example, located sideways with respect to the hollow body,
wherein the transfer element is located in the hollow body and wherein an outer perimeter of the transfer element substantially corresponds to an inner perimeter of the hollow body to be slidably moved inside the hollow body.

In particular, the transfer element may a separate part that is not attached to the hollow body.

It has been found that plastic filling pieces as known in the prior art may be prone to leaks due to deformation that is required for transferring the actuation movement during use thereof.

By having a transfer element that is slidably movable in the hollow body, deformation of the transfer element is not required to transfer an actuation movement of the actuator to the shutter. Less deformation and less chances on material fatigue may increase the leak-tightness of the filling piece, even upon frequent use.

In a further embodiment, the hollow body comprises an actuation opening at a second end, opposite to the first end of the hollow body, wherein the transfer element partially protrudes out of the hollow body through the actuation opening, and wherein the actuation opening is closed-off by the transfer element.

By having an actuation opening, the transfer element may be moved through the actuation opening, such that a flexible membrane or elastic part may be omitted. Such parts may be uneconomic to manufacture and have a limited lifespan due to material fatigue.

In a further embodiment, a diameter of the part of the transfer element protruding through the actuation opening, when the filling piece is coupled to the valve in the closed position thereof, is substantially equal to a diameter of the actuation opening. This way, leakage of gas through the actuation opening, in an open position of the valve, may be limited.

In a further embodiment, the actuator further comprises a lever that is pivotable with respect to the hollow body between a free position and an actuated position,
wherein the lever comprises a contact surface configured to engage with the part of the transfer element that protrudes through the actuation opening to, and
wherein the lever is, upon movement from the free position to the actuated position, configured to push the transfer element to move the shutter to the open position, in particular against a gas pressure in the gas tank.

By having a lever, a force exerted on the lever may be leveraged such that a larger actuation force is available for moving the transfer element in the actuation movement. Leveraging the force may be advantageous as the shutter may need to be moved against a gas pressure in the gas tank.

With the lever, the filling piece may be actuated easily with a relatively low force, for example with one finger. The filling piece may be actuated by pressing the lever towards the first end. Alternatively, the lever may be actuated by pulling the lever away from the first end.

Advantageously, the contact surface of the lever and a surface on the part of the transfer element that protrudes through the actuation opening are smooth, such that the contact surface of the lever and the surface on the part of the transfer element that protrudes through the actuation opening may slide past each other, whereby friction force between the respective forces is relatively low, such that the actuation force may be relatively low.

In an embodiment, the outflow opening is located in between the first end and the second end of the hollow body. This way, a compact configuration of the filling piece is achieved.

In an embodiment, the filling piece further comprises a nozzle, for example for inflating balloons, which is attached to the hollow body at the outflow opening thereof.

By having a nozzle, a balloon may be filled relatively easy by moving a balloon with an inflation opening thereof around the nozzle.

Further, screwing the second outer thread in the first outer thread for connecting the filling piece to the coupling piece may be performed easier due to the nozzle, as the nozzle may be used as a lever and/or as a grip to rotate the filling piece.

In an embodiment, the nozzle is integrally connected to the hollow body. As such, durability of the nozzle is increased, in particular when forces of balloons and/or screwing forces are exerted thereon.

In an embodiment, the nozzle comprises at least one detachable tip element. Multiple types of tip elements may be provided for inflating different types of balloons. The tip element may be detachable by using a releasably attachable connection. In particular, a snap-fit connection or bayonet-type connection may be arranged on the nozzle to facilitate easy and quick detachment and attachment of the tip element.

The tip element may be adapted for inflating latex balloons, such as a tip element comprising a tapered outer surface and/or be adapted for inflating foil balloons, such as a substantially cylindrical tip element.

By having at least one detachable tip element, the filling piece coupling assembly may conveniently be used for inflating different types of balloons using a single filling piece, without removing the filling piece from the coupling piece.

In an embodiment, the filling piece comprises a filling piece biasing element, such as a spring, to bias the transfer element away from the inflow opening, e.g. away from the shutter. The biasing element may provide a biasing force to bias the transfer element away from the shutter.

By having a biasing element, temporarily or accidentally moving the actuator may be made more difficult, as the transfer element is biased with the biasing force. As such, biasing of the biasing element is independent of a closing pressure exerted on the shutter of the valve, for example a gas pressure in the tank.

Further, by selecting a biasing force of the biasing element, for example by providing a spring having a specific spring constant, the actuation force required for the actuation movement may be influenced. This way, movement of the transfer element may require a predetermined force, for example a force that cannot be exerted by children.

In an embodiment, the valve comprises a valve biasing element, such as a spring, to bias the shutter in the closed position. The valve biasing element may provide a biasing force, resulting in a shutter biasing pressure acting upon the shutter, to bias the shutter in the closed position.

The valve biasing element may ensure proper closure of the valve. In particular, the movement of the shutter from the open position to the closed position may be independent of a closing pressure exerted on the shutter, for example a gas pressure in the tank.

The valve biasing element may be arranged within the hollow cylindrical housing. In particular, the valve may comprise a valve biasing element mounter, that mounts the valve biasing element between the shutter and the first end of the valve.

The valve may comprise an inner mounting thread that extends at least partially within the hollow cylindrical housing, wherein the biasing element mounter comprises a hollow ring provided with an outer mounting thread that substantially corresponds to the inner mounting thread to mount the biasing element mounter within the hollow cylindrical housing, for example wherein the valve biasing element mounter is located at the first end of the valve.

In an embodiment, the first internal thread and the second internal thread are coaxially aligned with each other. This way, the chances of movement of the transfer element away from the shutter, for example in a radial direction, during the actuation movement are reduced.

In an embodiment, an inner diameter of the first internal thread is smaller than an inner diameter of the second internal thread.

According to an aspect, the filling piece coupling assembly is provided with an integrated pressure release. The integrated pressure release may also provide advantages in a valve suitable for a filling piece coupling assembly according to the present invention, even when the filling piece is not yet provided.

A disadvantage of the filling devices of the prior art is that they rely on the gas tank for overpressure protection. Environmental conditions, such as heat or sunshine, chemical reactions or overfilling of the gas tank may result in higher gas pressure in the gas tank.

Usually, a burst disc is arranged in the wall of the gas tank as overpressure protection. The burst disc is weaker than the wall and is designed to break in the event of overpressure in the gas tank, such that an opening is created, through which gas can escape out of the gas tank. This way, explosion of the gas tank and dangerous situations can be prevented or reduced.

A disadvantage is that bursting of the burst disc may still cause some damage.

Furthermore, as bursting is not reversible, after occurrence of an overpressure, gas can flow freely in and out of the gas tank, even after the overpressure has disappeared.

The breakage of the disc therefore requires replacement of the disc and, particularly for disposable balloon gas tanks, of the entire gas tank.

Also, due to regulations that vary with time and location, overpressure protection is not always required, such that both tanks with and without burst disc are manufactured and the logistics and storage of the different types of gas tanks is relatively complex.

Therewith, other overpressure protection means may increase costs, weight and/or dimensions of the balloon gas tank, which is generally unwanted as portability and light weight are important for balloon gas tanks, particularly for low volume and/or single balloon gas tanks used for a particular occasion.

As a result of the above-mentioned disadvantages and associated economic considerations, balloon gas tanks are often disposed after a single use. The applicant has found that this is not always necessary from a technical point of view and is even undesirable from a sustainability point of view.

In an embodiment, the cylindrical housing comprises a stationary part provided with the first outer thread and an aperture, and a movable part that houses the shutter and that is located in the aperture. The movable part is movable relative to the stationary part between a standard position, in which the movable part is engaged with the stationary part and/or the coupling piece to close-off the aperture in a substantially gas tight manner, and a release position, in which the movable part is at least partially positioned at a distance from the stationary part, respectively the coupling piece, to allow gas to flow through the aperture.

The movable part is biased in the standard position with a safe rated pressure to be moved towards the release position when a gas pressure exerted on the movable part exceeds the safe rated pressure. The first outer thread is configured to cooperate with the first internal thread to form a gas-tight connection between the coupling piece and the valve, and the valve is located inside the interior of the coupling piece.

As such, the pressure release is integrated in the valve, such that a gas tank can be provided with a pressure release by screwing the valve in the coupling piece. An existing gas tank can thus be retrofitted with a pressure release.

As a result, only one type of gas tank needs to be manufactured and a valve that complies with local regulations may be arranged in the coupling piece. Via the coupling piece, the valve may be replaced independently of the gas tank, which is advantageous as the valve may be more maintenance-sensitive than a stationary gas tank.

By selecting a type of valve with a certain safe rated pressure, it may become possible to adjust the safe rated pressure to the type of gas and/or the age or usage history of the gas tank.

A further advantage is that, after the gas pressure in the tank has fallen below the safe rated pressure, the valve could move back to its standard position so that the tank could be used again. Should, nevertheless, damage occur to the valve, it can easily be replaced, such that disposal of the gas tank may be avoided.

As the valve is equipped with a movable part and a stationary part to provide pressure release when a gas pressure exerted on the movable part exceeds the safe rated pressure, the pressure release means of the gas tank may be protected in the coupling piece, while still being detachable. There is no need for a separate pressure release that sticks out of the gas tank, or a pressure release that is permanently attached to the gas tank. A faulty pressure release may be maintained or replaced easily with the valve. Therefore, the filling piece coupling assembly offers an all-in-one solution for a long service life of the gas tank.

In an embodiment, the coupling piece comprises at least one sealing surface, wherein the valve comprises a contra surface that substantially corresponds to the respective sealing surface to be pressed against each other during screwing the first outer thread in the first internal thread to form a gas-tight connection between the coupling piece and the valve, wherein the contra surface is arranged on the movable part.

By having the contra surface arranged on the movable part, the stationary part may be positioned at a predetermined depth in the coupling piece, which may be uninfluenced by potentially variable sealing forces between the coupling piece and the valve, for example sealing forces due to an o-ring. The valve may comprise a depth limitation surface to limit a screw depth of the stationary part in the coupling piece.

For example, when the safe rated pressure is delivered by a biasing element, such as a spring, the safe rated pressure may depend on the compression of the biasing element. The biasing element may be arranged parallel to the first outer thread on the valve. This way, a depth of the valve in the coupling piece, i.e. a screwing depth of the first outer thread in the first inner thread determines the safe rated pressure.

The valve may comprise a stop surface for positioning the valve at a predetermined depth within the coupling piece, to ensure correct placement of the valve, irrespective of a sealing position between them.

In an embodiment, the at least one sealing surface extends at least partially in a radial direction from the circumferential wall to cooperate with the contra surface. This way, the contra surface may be clamped against the respective sealing surface with the safe rated pressure.

The at least one sealing surface may be located nearby an outer end of the first internal thread. This outer end of the first internal thread may be a lower end of the first internal thread, being the end that projects towards the interior of the gas tank upon placement of the filling piece coupling assembly on the gas tank.

In an embodiment, the movable part is arranged concentrically in the aperture and concentric with the shutter and wherein the movable part forms a sleeve around the shutter, in which the shutter is movably located.

This way, the movable part, including the shutter, may be moved towards the release position without moving the shutter with respect to the movable part. As such, the pressure release, in case of over-pressure, may be carried irrespective of the position of the shutter, thus being carried out irrespective of a state of actuation by a user.

In an embodiment, the shutter comprises an engagement surface that is engageable with the transfer element of a filling piece, wherein the shutter is biased in the closed position, to be pushed towards the open position by the transfer element against the bias of the shutter, and wherein the movable part is, in the standard position, biased in a direction opposite to the bias of the shutter.

The shutter may be biased in a direction away from the engagement surface. The direction away from the engagement surface may be towards the transfer element. The shutter may be biased in the direction of the gas tank pressure, such that overpressure in the gas tank leave the shutter in the closed position. This way, overpressure may leave the shutter and the shutter bias unaffected, whereas actuation of the shutter by the transfer element may be carried out against the pressure in the gas tank. The shutter may be biased in a direction of the gas pressure in the tank.

In an embodiment, the shutter is biased in the closed position with a shutter biasing pressure, wherein the safe rated pressure is larger than the shutter biasing pressure. By having a relatively low shutter biasing pressure, the shutter may be actuated relatively easy, whereas manual actuation of the movable part with respect to the stationary part may be avoided as it may be unwanted.

In an embodiment, the safe rated pressure corresponds to a gas pressure of 40-80 bar, for example 60 bar. These values are well suited for a balloon gas tank and are selected to be above a normal pressure level for typical balloon gas tanks, but below a pressure level that could result into collapse of the gas tank.

In an embodiment, the coupling piece comprises a distinct second internal thread, which is aligned parallel to the first internal thread and spaced therefrom in an axial direction, wherein the second internal thread is configured to cooperate with a second outer thread of a filling piece to releasably connect the filling piece to the coupling piece, to form a gas-tight connection between the coupling piece and an inflow opening of the filling piece, wherein the first internal thread and the second internal thread are spaced away from each other such that the second internal thread does not interfere with the movable part in the release position.

This way, the movable part may operate effectively in case of an overpressure in the gas tank, because its operation does not interfere with the filling piece attached to the second internal thread. Effective pressure release may thus be safeguarded irrespective of the presence and/or position of a filling piece.

In an embodiment, the filling piece coupling assembly comprises a filling piece, separate from the valve, comprising a hollow body with an inflow opening and an outflow opening, defining a gas passage between the openings, an actuator with a movable transfer element, and a second outer thread, which substantially corresponds to the second internal thread of the coupling piece, wherein the second outer thread is configured to cooperate with the second internal thread to releasably connect the filling piece to the coupling piece, to form a gas-tight connection between the coupling piece and the inflow opening of the filling piece, and wherein the transfer element is engageable with the shutter of the valve, for example when the movable part is arranged in the standard position, to transfer an actuation movement of the actuator to the shutter to move the shutter to the open position.

In an embodiment, the transfer element, when the filling piece is releasably connected to the coupling piece, limits the movement of the shutter, when arranged in the closed position, towards the transfer element, such that that movement of the movable part towards the release position also causes movement of the shutter towards the open position due to engagement of the shutter with the transfer element.

In particular when the safe rated pressure is larger than the shutter biasing force, the gas pressure will cause movement of the movable part when exceeding the safe rated pressure, and may thereby cause the shutter to be moved towards the open position as well. This way, gas may escape from the gas tank trough a space between the stationary part and the movable part and/or via open shutter, to effectively increase the cross-sectional area of the overall passage through which pressure release can take place.

According to another aspect, the invention provides a valve of the filling piece coupling assembly as disclosed herein. The valve may comprise one or more of the features of the filling piece coupling assembly as disclosed herein, in particular as disclosed in the dependent claims, and similar benefits as of the coupling assembly may be achieved correspondingly with the valve.

The invention further provides a gas tank, comprising the coupling piece of the filling piece coupling assembly according to any of the embodiments disclosed herein, for example according to the present application.

When the coupling piece is fixed on the gas tank, the first outer end thereof may be directed towards the gas tank, for example towards the inner part of the gas tank. In particular, when the valve and the filing piece are connected to the coupling piece, the respective first threads and respective first ends are directed towards the gas tank, and the respective second threads and the respective second ends are directed away from the gas tank.

The circumferential wall of the coupling piece may be provided with a welding ridge to be positioned against an outer wall of a gas tank for welding the coupling element to the gas tank. In an embodiment, the coupling piece substantially extends inside the tank, for example, the welding ridge may be provided nearby the second outer end of the coupling piece. This way, additional protection of the coupling piece is provided.

When the coupling piece is welded to the gas tank at the welding ridge, a part of the circumferential wall between the welding ridge and the second outer end may extend from the tank and form a gripping surface for a tank handling device, in particular for an automatic tank filling device.

In an embodiment, a wall thickness of the coupling piece between the first end and the welding ridge is smaller than a wall thickness of the coupling piece between the second end and the welding ridge. This way, the part of the coupling piece that extends outside the gas tank, is provided with a larger wall thickness, such that it is better able to withstand external forces than a part of the coupling piece that extends inside the gas tank.

The gas tank may be a balloon gas tank for containing the balloon gas, such as a gas cylinder.

In an embodiment of the gas tank, the coupling piece is fixed to the gas tank by means of a welded connection. The welded connection may be provided between an outer wall of the tank and the welding ridge of the coupling piece. The weld may be gas tight.

In an embodiment, the gas tank comprises the filling piece coupling assembly according to any of the embodiments disclosed herein, for example according to the present application. This way, the benefits of the filling piece coupling assembly may be applied to the gas tank.

In an embodiment, the valve, when connected to the coupling piece, is arranged substantially inside the part of the coupling piece that extends inside the tank, for example at least for 50%, for example for at least 75% inside the part of the coupling piece that extends inside the tank. According to this embodiment, the valve is protected inside the tank. Handles or ears are not required on the tank for protection of the valve as the valve is protected by the coupling piece.

By having a valve arranged inside the part of the coupling piece that extends inside the tank, the second end of the valve may be arranged inwards with respect to the second outer end of the coupling piece. As such, the filling piece can be detached from the coupling piece, while the valve remains protected within the coupling piece.

In an embodiment, the valve forms the only pressure relief device and/or the safe rated pressure of the valve is less than a safe rated pressure of a burst disc pressure relief device of the gas tank.

This way, bursting of the burst disc may be avoided, and the gas thank may be reused upon occurrence of an overpressure in the gas tank.

According to another aspect, the invention provides a method for providing overpressure protection to a gas tank, e.g. a balloon gas tank, comprising the steps of providing a gas tank comprising the coupling piece of the filling piece coupling assembly according to any of the any the embodiments disclosed herein, for example according to the present application, connecting the valve to the coupling piece by means of the first internal thread and the first outer thread, and, optionally connecting the filling piece according to the coupling piece by means of the second internal thread and the second outer thread.

The invention further provides a method for coupling a filling piece and a valve to a coupling piece, e.g. to a gas tank, comprising the steps of:
providing the filling piece coupling assembly according to any the embodiments disclosed herein, for example according to the present application, connecting the valve to the coupling piece by means of the first internal thread and the first outer thread, and
connecting the filling piece to the coupling piece by means of the second internal thread and the second outer thread, preferably by rotating a mounting ring of the filling piece, provided with the second outer thread, with respect to the coupling piece, i.e. whilst holding the hollow body of the filling piece stationary.

With the method, similar benefits as with the filling piece coupling assembly can be achieved.

The invention further provides a method for refilling a gas tank according to any of the embodiments disclosed herein, for example according to the present application, comprising the steps of:
disconnecting, if present, the filling piece from the coupling piece by releasing the threaded connection between the second internal thread and the second outer thread,
filling the gas tank through the valve, and
optionally, connecting the filling piece to the coupling piece by means of the second internal thread and the second outer thread.

By having a combination of a coupling piece, valve and, optionally, a filling piece according to the present invention, a gas tank may be reused by refilling the gas tank.

In an embodiment, the step of filling the gas tank is performed through the valve upon moving the shutter to the open position and/or moving the movable part to the release position.

In an embodiment, wherein a part of the circumferential wall of the coupling piece extends from the gas tank between the welding ridge and the second outer edge and forms a gripping surface for a tank handling device, the step of filling the gas tank through the valve comprises the steps of:
gripping the gas tank with the tank handling device at the gripping surface; and
positioning the gas tank underneath a tank filling nozzle with the tank handling device.

In a further embodiment, the tank handling device is an automatic tank filling device. Due to the advantageous construction of the coupling piece, the filling piece coupling assembly may be particularly suited for automatic filling of the gas tank.

The valve, the coupling piece and/or the filling piece according to any embodiment of the invention may also be used individually and therewith also provide one or multiple of the advantages as mentioned herein without being comprised in a filling piece coupling assembly according to the invention.

### BRIEF DESCRIPTION OF DRAWINGS

Further characteristics of the invention will be explained below, with reference to embodiments, which are displayed in the appended drawings, in which:

FIG. 1 schematically depicts a side view of a cross section of an embodiment of a gas tank comprising a filling piece coupling assembly according to an embodiment of the invention;

FIG. 2A schematically depicts a side view of a cross section of the filing piece coupling assembly of FIG. 1, wherein the filling piece has been hidden, wherein the movable part is in the standard position;

FIG. 2B schematically depicts a side view of a cross section of the filing piece coupling assembly of FIG. 1, with the shutter of the valve arranged in the open position, wherein the movable part is in the standard position;

FIG. 2C schematically depicts a side view of a cross section of the filing piece coupling assembly of FIG. 1, with the movable part is moved into the release position;

FIG. 3 schematically depicts a perspective view of a valve according to the embodiment of FIG. 1; FIG. 4A schematically depicts a side view of a cross section of a filing piece coupling assembly according to another embodiment, with the shutter of the valve arranged in the closed position;

FIG. 4B schematically depicts a side view of a cross section of the filing piece coupling assembly of FIG. 4A, with the shutter of the valve arranged in the open position;

FIG. 5A schematically depicts a perspective view of a valve according to the embodiment of FIG. 4A;

FIG. 5B schematically depicts a side view of a cross section of the valve of FIG. 5B;

FIG. 6A schematically depicts a perspective view of a coupling piece according to the embodiments of FIG. 4A;

FIG. 6B schematically depicts a side view of the coupling piece of FIG. 6A;

FIG. 7A schematically depicts a perspective view of a filling piece according to the embodiments of FIGS. 1 and 4A;

FIG. 7B schematically depicts a side view of a cross section of the filling piece of FIG. 7A.

FIG. 8A schematically depicts a perspective view of a filling piece according to another embodiment of the invention;

FIG. 8B schematically depicts a side view of a cross section along line A-A in FIG. 8A;

FIG. 8C schematically depicts a bottom view of a cross section along line B-B in FIG. 8B;

FIG. 8D schematically depicts the mounting ring of FIG. 8B; and

FIG. 9 schematically depicts a side view of a filling piece coupling assembly according to the embodiment of FIG. 1, wherein the shutter is arranged in the open position, and wherein the movable part is arranged in the release position.

Throughout the figures, the same reference numerals are used to refer to corresponding components or to components that have a corresponding function.

### DETAILED DESCRIPTION OF EMBODIMENTS

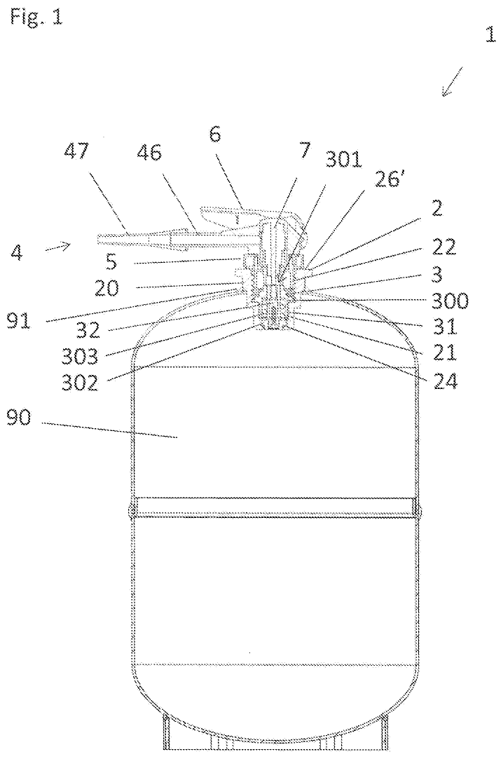

FIG. 1 schematically depicts a side view of a cross section of an embodiment of a gas tank 90, for example containing pressurized helium gas, comprising a filling piece coupling assembly 1 according to an embodiment of the invention.

The filling piece coupling assembly 1 comprises a coupling piece 2 configured to be fixed to the gas tank 90. The coupling piece 2 comprises a circumferential wall 20, which defines an interior space 23. The circumferential wall 20 comprises a first internal thread 21 and a distinct second internal thread 22, which are aligned parallel to each other and spaced from each other in an axial direction.

The filling piece coupling assembly 1 further comprises a valve 3, which comprises a hollow cylindrical housing 30 that is provided with a first outer thread 31. The first outer thread 31 substantially corresponds to the first internal thread 21 of the coupling piece 2. The first outer thread 31 is configured to cooperate with the first internal thread 21 to form a gas-tight connection between the coupling piece 2 and the valve 3. T

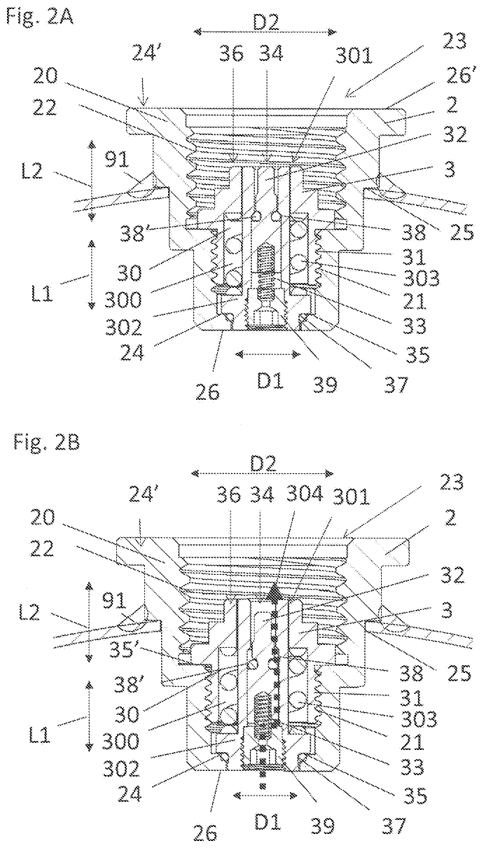

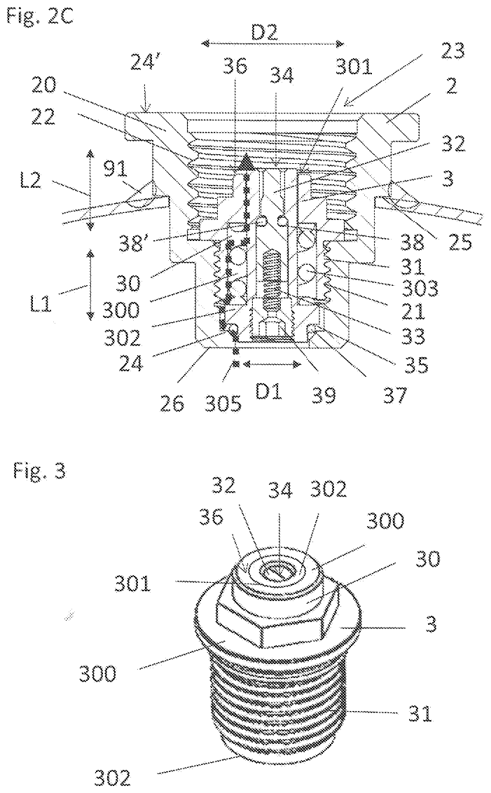

A shutter 32 is provided that is located in the housing 30 and movable with respect to the housing 30 between a closed position, in which the shutter 32 is engaged with the housing 30 to be substantially gas tight as depicted in FIG. 2A, and an open position, in which the shutter 32 is at least partially positioned at a distance from the housing 30 to allow gas to flow through the valve 3, as depicted in FIG. 2B.

The cylindrical housing 30 comprises a stationary part 300 provided with the first outer thread 31 and an aperture 301, and a movable part 302 that houses the shutter 32 and that is located in the aperture 301.

The movable part 302 is movable relative to the stationary part 300 between the standard position, in which the movable part 302 is engaged with the coupling piece 2 to close-off the aperture 301 in a substantially gas tight manner, and a release position, in which the movable part 302 is at least partially positioned at a distance from the coupling piece 2, to allow gas to flow through the aperture 301.

The movable part 302 is biased in the standard position with a safe rated pressure by a spring 303. The movable part 302 may be moved towards the release position when a gas pressure exerted on the movable part exceeds the safe rated pressure of the spring 303. This way, the movable part 302 with the spring 303 forms a pressure release integrated in the valve 3. The first outer thread 31 is configured to cooperate with the first internal thread 21 to form a gas-tight connection between the coupling piece and the valve, and the valve is located inside the interior of the coupling piece.

The movable part 302 is arranged concentrically in the aperture 301 and with the shutter 32. The movable part 302 forms a sleeve around the shutter, in which the shutter 32 is movably located.

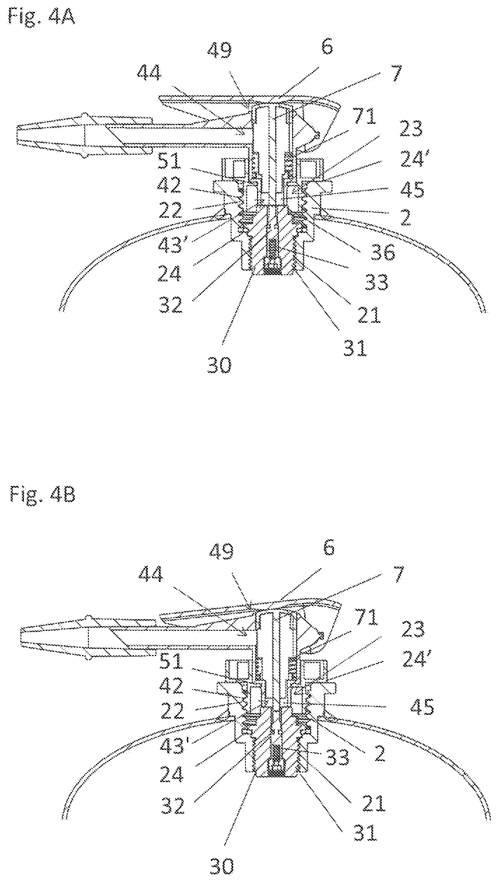

In the embodiments of FIG. 4A-4B the cylindrical housing 30 is formed by a single part.

The filing piece coupling assembly 1 comprises a filling piece 4 that is separate from the valve 2. The filling piece 4 comprises a hollow body 40 with an inflow opening 43′ and an outflow opening 44, which define a gas passage 45 between the inflow opening 43′ and the outflow opening 44. The filling piece 4 also comprises a second outer thread 42, which substantially corresponds to the second internal thread 22 of the coupling piece 2. The second outer thread 42 is configured to cooperate with the second internal thread 22 to releasably connect the filling piece 4 to the coupling piece 2, to form a gas-tight connection between the coupling piece 4 and the inflow opening 43′.

The filling piece comprises an actuator 6, 7 with a movable transfer element 7, which is engageable with the shutter 32 of the valve 3, to transfer an actuation movement of the actuator 6, 7 to the shutter 32 to move the shutter 32 to the open position.

The transfer element 7 is engageable with the shutter 32 by pushing. The shutter 32 comprises an engagement surface 34 that is engageable with a transfer element 7 of a filling piece 4, which upon coupling the valve with the filling piece, faces the transfer element 7.

The engagement surface 34 of the shutter 32 may be provided with a centring structure to avoid slip or deflection of the transfer element on the shutter, or vice versa. The centring structure may for example be a dimple or recess located centrally on the engagement surface 34. In the shown embodiments, the centring structure is a groove.

The valve 3 is arranged substantially inside the part of the coupling piece 2 that extends inside the gas tank 90, in particular at least 75%. The lower side of the valve is the first end and an opposite side of the valve is the second end. The second end of the valve is arranged inwards with respect to an outer end 26′ of the coupling piece 2. No handles or ears are provided on the tank 90.

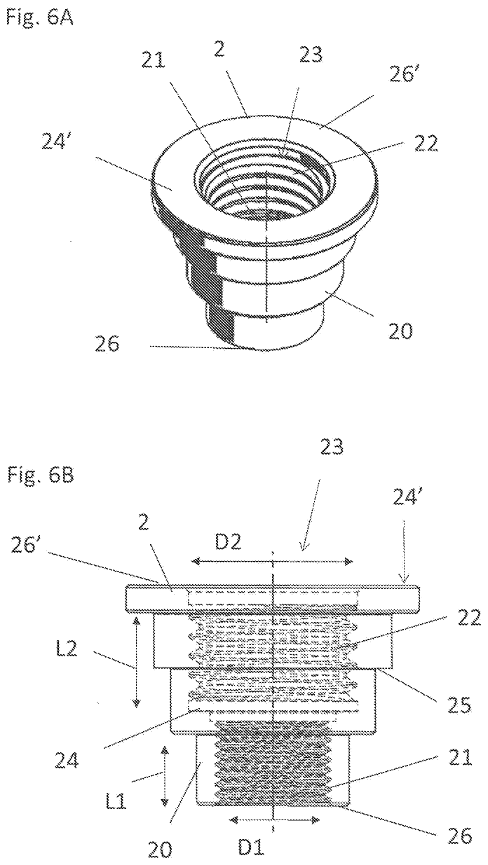

FIG. 6A schematically depicts a perspective view of a coupling piece according to an embodiment of the invention, and FIG. 6B schematically depicts a side view of the coupling piece of FIG. 6A, wherein the first internal thread 21 and the second internal thread 22 are displayed in a dotted line.

The first internal thread 21 and the second internal thread 22 are coaxially aligned with each other. An inner diameter D1 of the first internal thread 21 is smaller than an inner diameter of the second internal thread 22. The first internal thread 21 and the second internal thread 22 are spaced away from each other such that the second internal thread 22 does not interfere with the movable part 302 in the release position.

An inner diameter D1 of the first internal thread 21 is smaller than an inner diameter D2 of the second internal thread 22.

The second internal thread 22 of the coupling piece 2 has a length L2 that is larger than a length L2′ of the second external thread 42 of the filling piece 4. This way, screwing of the second external thread 42 in the second internal thread 22 for connecting the filling piece 4 with the coupling piece 2 is not limited by the respective threads, but instead by contact between other surfaces of the coupling piece 2 and the valve 3 and/or the filling piece 4.

The coupling piece comprises a first outer end 26, wherein the first internal thread 21 extends towards the first outer end 21 of the coupling piece 2, and a second outer end 26′, wherein the second internal thread 22 extends towards the second outer end 26′ of the coupling piece 2.

The coupling piece 2 comprises a welding ridge 25 to be positioned against an outer wall of the tank 90 for welding the coupling piece 2 thereto, such that a part of the circumferential wall 20 extending between the welding ridge 25 and the second outer end 26′ may extend from tank 90 and form a gripping surface for a tank handling device, in particular for an automatic tank filling device.

A wall thickness of the coupling piece 2 between the welding ridge 25 and the first end 26 is smaller than a wall thickness of the coupling piece 2 between the second end 26′ and the welding ridge 25.

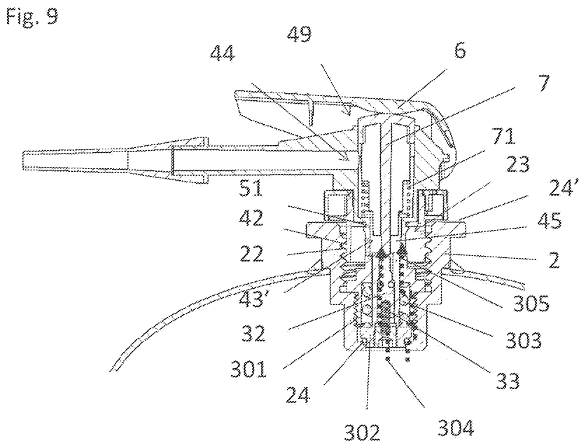

The coupling piece 2 comprises a first sealing surface 24 located at the second outer end 26′ that extends from the circumferential wall 20 at least partially in a radial direction, from the circumferential wall 20. In the embodiment of FIG. 6B, the first sealing surface 24 is arranged between the first internal thread 21 and the second internal thread 22. However, the first sealing surface 24 may also be arranged on other positions, such as at the first outer end 26, for example nearby a lower outer end of the first internal thread 21, as shown in FIG. 1, 2A-2C and FIG. 9.

The valve 3 comprises a first contra surface 35 that substantially corresponds to the first sealing surface 24 to be pressed against each other during screwing the first outer thread 31 in the first internal thread 21 to form a gas-tight connection between the coupling piece 2 and the valve 3. The first contra surface 35 is arranged on a position corresponding to the first sealing surface 24 of the coupling piece 2 and extends in a radial direction from the cylindrical housing 30 of the valve 3 and comprises a groove for seating a gasket or O-ring 37. For example, in the embodiment of FIG. 4A-6B, the first sealing surface 24 is arranged to be tightened by the first outer thread 31 to seal with the first contra surface 35.

In FIG. 1-3, the first contra surface 35 is arranged on the movable part 302 and the valve comprises a depth limitation surface 35′ that does not necessarily seal but limits a screw depth of the stationary part in the coupling piece such that a length of spring 303 when the valve 3 is mounted in the coupling piece 2 is predetermined. Therewith, the safe rated pressure may be predetermined.

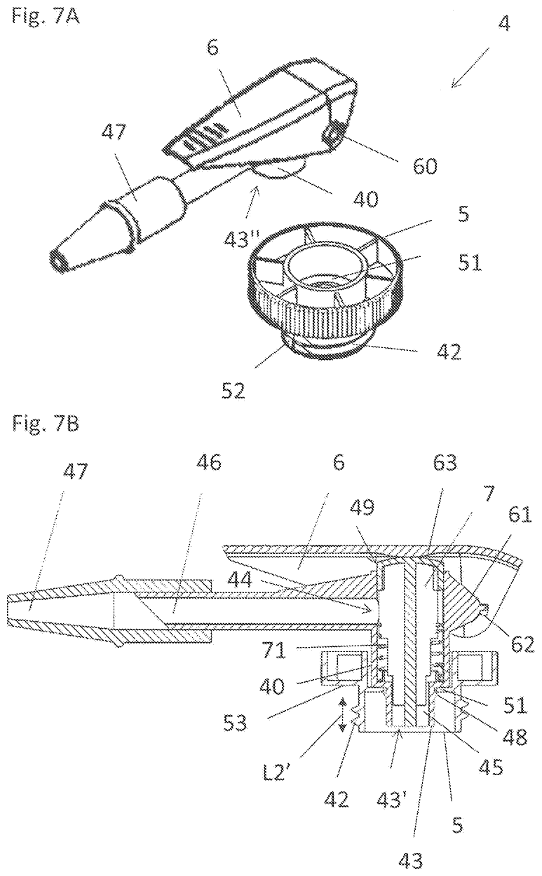

The valve 3 comprises a second sealing surface 36 that extends at the second end of the valve 3 at least partially in a radial direction. The second sealing surface 36 formed by an upper outer wall of the housing 30. The filing piece 4, as depicted in FIGS. 7A and 7B, comprises a second contra surface 43 formed by the surface of the hollow body 40 that surrounds the inflow opening 43′. The second contra surface 43 substantially corresponds to the second sealing surface 36.

The coupling piece 2 comprises a third sealing surface 24′, that extends from the circumferential wall 20 at least partially in a radial direction at the second outer end 26′. The filling piece 4 comprises a third contra surface 53 that substantially corresponds to the third sealing surface 24′.

The second sealing surface 36 and third sealing surface 24′, are configured to be pressed against the respective second contra surface 43 and third contra surface 53 during screwing the second outer thread 42 in the second internal thread 22.

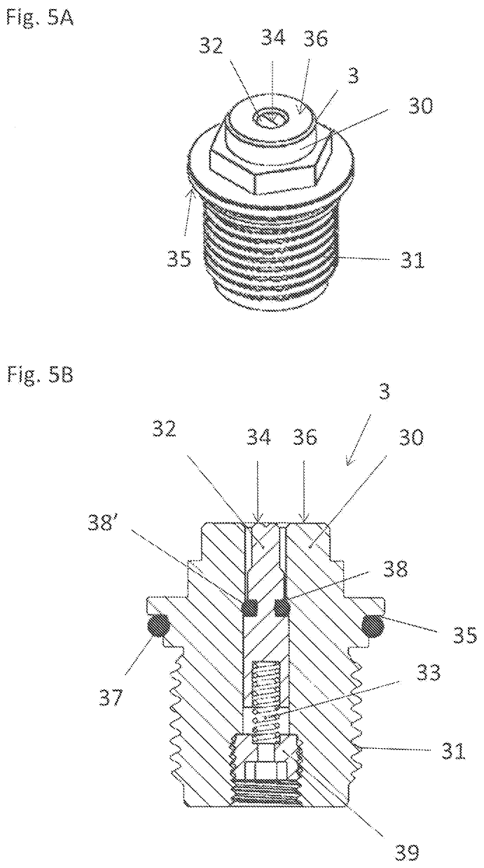

The valve 3, as depicted in FIGS. 3, 5A and 5B, is provided with a tool coupling arranged on the cylindrical housing 30. The tool coupling is a hexagonal socket.

In the shown embodiments, the hollow cylindrical housing 30 comprises a constriction 38, to which the shutter 32 is engaged in the closed position to be substantially gas tight. In particular, the shutter may be provided with a seal 38′, such as an O-ring or gasket. In the open position, the seal 38′ of the shutter 32 is positioned at a distance from the constriction 38 in the housing to allow gas to flow through the valve 3, for example via pathway 304.

The valve 3 comprises a valve biasing element 33, such as a spring, that provides a biasing force towards the transfer element 7 to bias the shutter 32 in the closed position of FIGS. 2A, 2C, 3, 5A and 5B. The valve biasing element 33 is arranged within the hollow cylindrical housing 30 and held therein by the valve biasing element mounter 39.

The shutter 32 may be pushed into the open position by the transfer element 7 engaging the transfer element 8 and pushing against engagement surface 34.

In FIG. 1-3, the movable part 302 is, in the standard position, biased by spring 303 in a direction opposite to the shutter bias, towards a gas tank 90.

The safe rated pressure from spring 303 is larger than the shutter biasing pressure from spring 33. The safe rated pressure corresponds to a gas pressure in the gas tank of 40-80 bar, for example 60 bar in this embodiment. When this pressure is exceeded, the movable part 302 may move towards the release position to enable gas to flow out of the tank 90, for example through the aperture 301 via pathway 305.

The valve biasing element mounter 39 comprises a hollow ring provided with an outer mounting thread that substantially corresponds to an inner mounting thread that at least partially extends within the hollow cylindrical housing 30. The inner mounting thread is located at a first end of the valve, and after screwing the valve biasing element mounter 39 in the mounting thread, the valve biasing element mounter 39 mounts the valve biasing element 33 between the shutter 32 and the first end of the valve 3.

In FIG. 1-3, the tool coupling is provided on the stationary part 300 and the valve biasing element 33 is arranged within the movable part 302. The inner mounting thread extends within the movable part 302 of the hollow cylindrical housing 30, and the valve biasing element mounter 39 mounts the valve biasing element 33 between the shutter 32 and the movable part 302 near the first end of the valve 3. The valve 3 forms the only pressure relief device of the gas tank 90. However in other embodiments, additional pressure relief valves may be provided.

In an embodiment, as depicted in FIG. 9, the transfer element 7, when the filling piece 4 is releasably connected to the coupling piece 2, limits the movement of the shutter 32, when arranged in the closed position, towards the transfer element 7, such that that movement of the movable part 302 towards the release position also causes movement of the shutter 32 towards the open position due to engagement of the shutter 32 with the transfer element 7. As such, gas may escape from the gas tank 90 through a space between the stationary part 301 and the movable part 302, as shown as path 303, and simultaneously via the open shutter, as shown as path 304.

The filling piece 4, as depicted in FIGS. 7A, 7B, comprises a second contra surface 53 that substantially corresponds to the second sealing surface 24′ to be pressed against each other during screwing the second outer thread 42 in the second internal thread 22 to form a gas-tight connection between the coupling piece 2 and the filling piece 4.

The filling piece 4 comprises a mounting ring 5 that is rotatably connected to the hollow body 40 by means of a form-fit connection, in particular a snap-fit connection formed by inwardly protruding ridge 51 on the mounting ring 5, and an outwardly protruding latch 48.

The second outer thread 42 is provided on the mounting ring 5 and the second sealing surface 53 of the filling piece 4 is arranged on the mounting ring 5, in particular formed by the side of the mounting ring 5 that faces the second outer thread 42.

The second outer thread 42 comprises a flattened portion 52 that extends in axial direction over a portion of the second outer thread 42.

The transfer element 7 is a separate element that is slidably movable and located in the hollow body 40, and has an outer perimeter that substantially corresponds to an inner perimeter of the hollow body 40.

The hollow body 4 comprises an actuation opening 49 at a second end opposite to the first end of the hollow body 4. The transfer element 7 partially protrudes out of the hollow body 40 through the actuation opening 49. A diameter of the part of the transfer element 7 protruding through the actuation opening 49 is substantially equal to a diameter of the actuation opening 49, such that the actuation opening is closed off by the transfer element 7.

The inflow opening 43′ is arranged at a first end of the hollow body 40 and the outflow opening 44 is located sideways with respect to the hollow body 40, between the first end of the hollow body and the second end thereof.

The actuator 6, 7 comprises a lever 6 that is pivotable with respect to the hollow body 40 around a pivot hinge 60 formed by protrusion 61 of the hollow body 40 and recess 62 in the lever 6. A shape of the protrusion 61 and recess 62 substantially corresponds to allow movement of the recess 62 around the protrusion 61. Additionally the shapes of the protrusion 61 and of the recess 62 are adapted to limit movement of the lever 6 with respect to the hollow body 40.

The lever 6 comprises a smooth contact surface 63 configured to engage with a smooth surface on the part of the transfer element 7 that protrudes through the actuation opening 49. The lever 6 is, upon movement from the free position of the lever 7, as depicted in FIG. 4A, to the actuated position of the lever 7, as depicted in FIG. 4B, configured to push the transfer element 7 to move the shutter 32 to the open position, in particular against a gas pressure in the gas tank.

The filling piece 4 further comprises a nozzle 46 for inflating balloons, attached to the hollow body 40 at the outflow opening 44. The nozzle 46 is integrally connected to the hollow body.t The nozzle 46 comprises a detachable tip element 47.

The detachable tip element 47 is tapered and provided with a circumferential ridge protruding along the outer circumference against which the spout of a balloon can be held to inflate the balloon.

Furthermore, the filling piece 4 comprises filling piece biasing element 71, in particular a spring, that biases the transfer element 7 within the hollow body 40, towards the lever 6 and away from the inflow opening 43′ and, when the valve 3 and the filling piece 4 coupled to the coupling piece 2, away from the shutter 34.

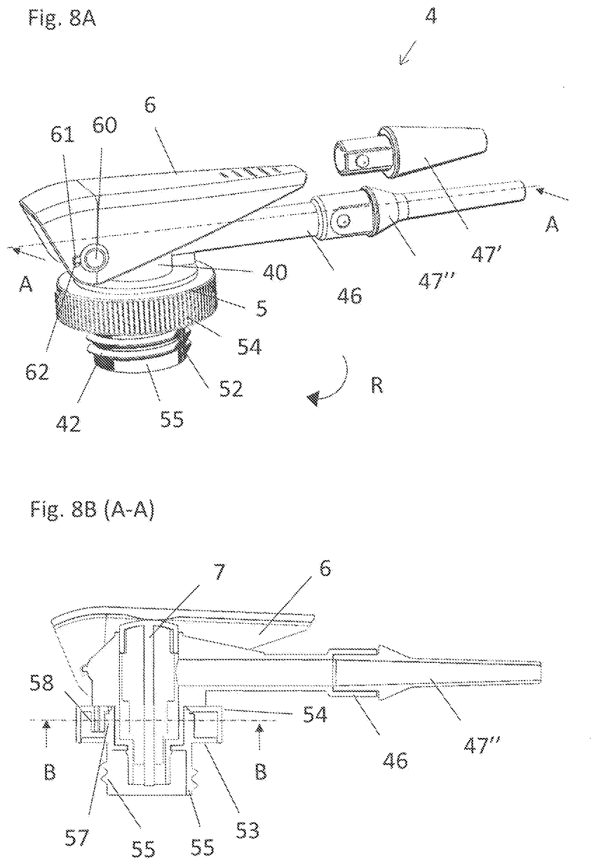

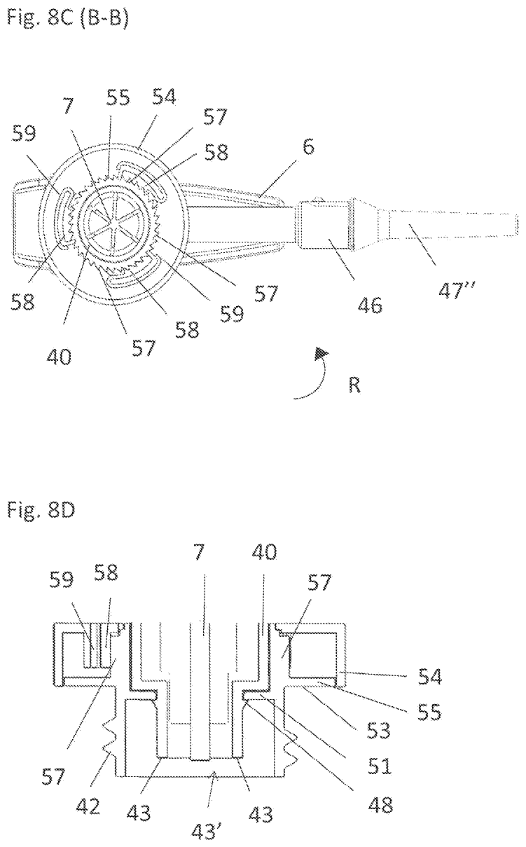

In FIG. 8A-8D a filling piece 4 according to another embodiment is depicted. The nozzle 46 comprises two detachable tip elements 47′, 47″ for inflating different types of balloons that are selectively attachable using a releasably attachable connection, in particular a snap fit connection. A first tip element 47′ is adapted for inflating latex balloons, and comprises a tapered outer surface. A second tip element 47″ is adapted for inflating foil balloons, and comprises a substantially cylindrical shape.

FIG. 8B schematically depicts a side view of a cross section along line A-A in FIG. 8A; FIG. 8C schematically depicts a bottom view of a cross section along line B-B in FIG. 8B; and FIG. 8D schematically depicts the mounting ring of FIG. 8B.

The mounting ring 5 comprises a grip part 54 and threaded part 53 distinct from the grip part 54 and provided with the second outer thread 42. The grip part 54 and the threaded part 53 are coaxially aligned. The threaded part 53 is provided with teeth 57 that are arranged in a circle around a middle point of the mounting ring 5, and the grip part is provided with three ratchets 58 to cooperate with the teeth 57. The teeth 57 and the ratchets 58 form the transfer mechanism.

As depicted in FIG. 8C, the ratchets 58 are provided with flexible elongate elements 59 that act as a spring blade and push the respective ratchets against the teeth 57. The flexible elongate elements 59 bias the ratchets 58 in a first state wherein the ratchets 58 are pushed against the teeth 57 to transfer a rotation movement R applied to the grip part 54 to the threaded part 53.

Due to the sloped shape of the teeth 57 in rotation direction R, the respective ratchets 58 may be pushed towards the respective elongate flexible element 59, thereby allowing the respective ratchets 58 to slip along the teeth 57 when a predetermined threshold force is exceeded. This way, when the second contra surface 43 is pressed against the second sealing surface 36 of the valve and/or when the third contra surface 53 is pressed against the third sealing surface 24′ of the coupling piece, the predetermined threshold force is exceeded, such that the ratchets 58, in a second state, slip along the teeth 57 and screwing the second outer thread 42 in the second inner thread 22 too far may be avoided.

When the ratchets 58 slip along the teeth 57, an audible click is produced.

The coupling piece 2 may be welded to a gas tank 90. The valve 3 can then be connected to the coupling piece 2 by screwing the first outer thread 31 of the valve 3 in the first internal thread 21 of the coupling piece 2, such that the valve 3 is located inside the interior 23 of the coupling piece 2. Then, the filling piece 4 may be detachably connected to the coupling piece 2 by subsequent insertion of the second outer thread 42 into the second internal thread 22, after which the second outer thread 42 is screwed in the second internal thread 22 to form a gas-tight connection between the coupling piece 2 and the inflow opening 43′ of the filling piece 4.

As the shutter 32 is biased by biasing element 33, the shutter 32 is normally in the closed position and the hollow body 40 of the filling piece can be at ambient pressure.

In order to fill a balloon, a balloon may be provided at the nozzle 46. Then, the lever 6 is pushed in an actuation movement in a downward direction towards the shutter 32 of the valve 3, causing a downward movement of the transfer element 7 that is transferred to the shutter 32 and pushes the shutter 32 away from the housing 30 towards the open position, against the gas pressure in the gas tank 90 and/or the biasing force from the valve biasing element 33.

In the open position of the shutter 32, a gas tank 90, the outflow opening 44 of the filling piece 40 and, via the nozzle 46, a balloon are fluidly connected via the coupling piece, such that gas can flow out of the tank 90 and through the outflow opening 44 to inflate a balloon.

When a different type of balloon is to be inflated, the tip element 47, for example the first tip element 47′ may be detached and another tip element 47, for example the second tip element 47″ may be releasably attached without removing the filling piece from the coupling piece.

The gas tank 90 may be refilled by disconnecting the filling piece 4, if present, from the coupling piece 2 by releasing the threaded connection between the second internal thread 22 and the second external thread 42, for example by unscrewing.

Then, the valve 3 may be accessed to allow refilling the gas tank 90 through the valve 3 and, optionally the filling piece 4 can be connected to the coupling piece 2 again.

The tank 90 may be handled by gripping the gripping surface formed by the part of the circumferential wall 20 that extends from the tank 90 between the welding ridge 25 and the second outer end 26′ with a tank handling device, to position the gas tank 90 underneath a tank filling nozzle, such that the tank 90 may be filled with an automatic tank filling device.

The tank handling device may be an automatic tank filling device.

Alternative and/or additional embodiments may be described in the following list of embodiments:

E1. Filling piece coupling assembly with integrated pressure release (1), configured to be connected to a gas tank (90), for example containing pressurized helium gas, comprising:
a coupling piece (2), configured to be fixed to the gas tank (90) and comprising a circumferential wall (20), which defines an interior (23) of the coupling piece,
wherein the circumferential wall (20) comprises a first internal thread (21); and
a valve (3), comprising a hollow cylindrical housing (30) provided with a first outer thread (31), which substantially corresponds to the first internal thread (21) of the coupling piece (2), and with a shutter (32) that is located in the housing (30) and movable with respect to the housing (30) between a closed position, in which the shutter (32) is engaged with the housing (30) to be substantially gas tight, and an open position, in which the shutter (32) is at least partially positioned at a distance from the housing (30) to allow gas to flow through the valve (3), wherein the cylindrical housing (30) comprises:
a stationary part (300) provided with the first outer thread (31) and an aperture (301), and
a movable part (302) that houses the shutter (32) and that is located in the aperture (301),
wherein the movable part (310) is movable relative to the stationary part (300) between a standard position, in which the movable part is engaged with the stationary part and/or the coupling piece to close-off the aperture in a substantially gas tight manner, and a release position, in which the movable part is at least partially positioned at a distance from the stationary part, respectively the coupling piece, to allow gas to flow through the aperture,
wherein the movable part is biased in the standard position with a safe rated pressure to be moved towards the release position when a gas pressure exerted on the movable part exceeds the safe rated pressure,
wherein the first outer thread (31) is configured to cooperate with the first internal thread (21) to form a gas-tight connection between the coupling piece (2) and the valve (3), and
wherein the valve (3) is located inside the interior of the coupling piece (2).

E2. Filling piece coupling assembly (1) according to embodiment E1, wherein the coupling piece (2) comprises at least one sealing surface (24), wherein the valve comprises a contra surface (35) that substantially corresponds to the respective sealing surface to be pressed against each other during screwing the first outer thread in the first internal thread to form a gas-tight connection between the coupling piece and the valve, wherein the contra surface is arranged on the movable part.

E3. Filling piece coupling assembly (1) according to embodiment E2, wherein the at least one sealing surface (24) extends at least partially in a radial direction from the circumferential wall (20) to cooperate with the contra surface and wherein the at least one sealing surface is located nearby an outer end of the first internal thread.

E4. Filling piece coupling assembly (1) according to any of the preceding embodiments, wherein the movable part is arranged concentrically in the aperture and concentric with the shutter and wherein the movable part forms a sleeve around the shutter, in which the shutter is movably located.

E5. Filling piece coupling assembly (1) according to any of the preceding embodiments, wherein the shutter comprises an engagement surface that is engageable with a transfer element of a filling piece, wherein the shutter is biased in the closed position, in a direction away from the engagement surface, to be pushed towards the open position by the transfer element, and wherein the movable part is, in the standard position, biased in a direction opposite to the bias of the shutter.

E6. Filling piece coupling assembly according to any of the preceding embodiments, wherein the shutter is biased in the closed position with a shutter biasing pressure, wherein the safe rated pressure is larger than the shutter biasing pressure.

E7. Filling piece coupling assembly according to any of the preceding embodiments, wherein the safe rated pressure corresponds to a gas pressure of 40-80 bar, for example 60 bar.

E8. Filling piece coupling assembly (1) according to any of the preceding embodiments, wherein the coupling piece comprises a distinct second internal thread (22), which is aligned parallel to the first internal thread (21) and spaced therefrom in an axial direction, wherein the second internal thread (22) is configured to cooperate with a second outer thread (42) of a filling piece (4) to releasably connect the filling piece (4) to the coupling piece (2), to form a gas-tight connection between the coupling piece (4) and an inflow opening (43′) of the filling piece (4),
wherein the first internal thread and the second internal thread are spaced away from each other such that the second internal thread does not interfere with the movable part in the release position.

E9. Filling piece coupling assembly according to the preceding embodiment, further comprising a filling piece (4), separate from the valve (2), comprising a hollow body (40) with an inflow opening (43′) and an outflow opening (44), defining a gas passage (45) between the openings (43′, 44), an actuator (6, 7), with a movable transfer element (7), and a second outer thread (42), which substantially corresponds to the second internal thread (22) of the coupling piece (2), wherein the second outer thread (42) is configured to cooperate with the second internal thread (22) to releasably connect the filling piece (4) to the coupling piece (2), to form a gas-tight connection between the coupling piece (4) and the inflow opening (43′) of the filling piece (4), and
wherein the transfer element (7) is engageable with the shutter (32) of the valve (3), for example when the movable part is arranged in the standard position, to transfer an actuation movement of the actuator (6, 7) to the shutter (32) to move the shutter (32) to the open position.

E10. Filling piece coupling assembly according to embodiment E6 and E9, wherein the transfer element, when the filling piece is releasably connected to the coupling piece, limits the movement of the shutter, when arranged in the closed position, towards the transfer element, such that that movement of the movable part towards the release position also causes movement of the shutter towards the open position due to engagement of the shutter with the transfer element.

E11. Valve of the filling piece coupling assembly according to any of the preceding embodiments.

E12. Gas tank, comprising the coupling piece of the filling piece coupling assembly according to any of the embodiments E1-E10 and/or the valve according to embodiment E11.

E13. Gas tank according to embodiment E12, wherein the valve forms the only pressure relief device and/or wherein the safe rated pressure of the valve is less than a safe rated pressure of a burst disc pressure relief device of the gas tank.

E14. Method for providing overpressure protection to a gas tank, e.g. a balloon gas tank, comprising the steps of:
providing a gas tank comprising the coupling piece of the filling piece coupling assembly according to any of the embodiments E1-E10 and/or the valve according to embodiment E11,
connecting the valve to the coupling piece by means of the first internal thread and the first outer thread,
optionally connecting the filling piece of the filling piece coupling assembly according to embodiment E9 or E10 to the coupling piece by means of the second internal thread and the second outer thread.

E15. Method for refilling a gas tank according to any of the embodiments E12-E13, comprising the steps of:
disconnecting, if present, the filling piece from the coupling piece by releasing the threaded connection between the second internal thread and the second outer thread,
filling the gas tank through the valve upon moving the shutter to the open position and/or moving the movable part to the release position, and
optionally, connecting the filling piece to the coupling piece by means of the second internal thread and the second outer thread.

1. A filling piece coupling assembly, for filling a balloon, configured to be connected to a gas tank, containing pressurized helium gas, comprising:
a coupling piece, configured to be fixed to the gas tank and comprising a circumferential wall, which defines an interior of the coupling piece,
wherein the circumferential wall comprises a first internal thread and a distinct second internal thread, which are aligned parallel to each other and spaced from each other in an axial direction,
a valve, comprising a hollow cylindrical housing provided with a first outer thread, which substantially corresponds to the first internal thread of the coupling piece, and with a shutter that is located in the housing and movable with respect to the housing between a closed position, in which the shutter is engaged with the housing to be substantially gas tight, and an open position, in which the shutter is at least partially positioned at a distance from the housing to allow gas to flow through the valve,
wherein the first outer thread is configured to cooperate with the first internal thread to form a gas-tight connection between the coupling piece and the valve, and wherein the valve is located inside the interior of the coupling piece, and
a filling piece, separate from the valve, comprising a hollow body with an inflow opening and an outflow opening, defining a gas passage between the openings, an actuator, with a movable transfer element, and a second outer thread, which substantially corresponds to the second internal thread of the coupling piece,
wherein the second outer thread is configured to cooperate with the second internal thread to releasably connect the filling piece to the coupling piece, to form a gas-tight connection between the coupling piece and the inflow opening of the filling piece, and
wherein the transfer element is engageable with the shutter of the valve, to transfer an actuation movement of the actuator to the shutter to move the shutter to the open position, such that the gas tank and the outflow opening of the filling piece are fluidly connected via the coupling piece, and gas can flow out of the tank and through the outflow opening to inflate a balloon.

2. The filling piece coupling assembly according to claim 1, wherein the filling piece comprises a mounting ring that is rotatable with respect to the hollow body, wherein the second outer thread is provided on the mounting ring.

3. The filling piece coupling assembly according to claim 2, wherein the mounting ring is rotatably connected to the hollow body by means of a form-fit connection, for example by latching behind a ridge, such as that the mounting ring is rotatably connected to the hollow body by means of a snap-fit connection.

4. The filling piece coupling assembly according to claim 2, wherein the mounting ring comprises a grip part and threaded part that is distinct from the grip part, wherein the grip part is movably connected to the threaded part via a transmission mechanism to transmit a rotation movement of the grip part to the threaded part via the transmission mechanism to rotate the second outer thread.

5. The filling piece coupling assembly according to claim 2, wherein, the coupling piece comprises at least one sealing surface, that extends from the circumferential wall at least partially in a radial direction, wherein the filling piece comprises a contra surface that substantially corresponds to the sealing surface to be pressed against each other during screwing the second outer thread in the second internal thread to form a gas-tight connection between the coupling piece and the filling piece, wherein the second sealing surface of the filing piece is arranged on the mounting ring.

6. The filling piece coupling assembly according to claim 1, wherein the cylindrical housing comprises a stationary part provided with the first outer thread and an aperture, and a movable part that houses the shutter and that is located in the aperture,
wherein the movable part is movable relative to the stationary part between a standard position, in which the movable part is engaged with the stationary part and/or the coupling piece to close-off the aperture in a substantially gas tight manner, and a release position, in which the movable part is at least partially positioned at a distance from the stationary part, respectively the coupling piece, to allow gas to flow through the aperture, wherein the movable part is biased in the standard position with a safe rated pressure to be moved towards the release position when a gas pressure exerted on the movable part exceeds the safe rated pressure.

7. The filling piece coupling assembly according to claim 6, wherein the coupling piece comprises at least one sealing surface, wherein the valve comprises a contra surface that substantially corresponds to the respective sealing surface to be pressed against each other during screwing the first outer thread in the first internal thread to form a gas-tight connection between the coupling piece and the valve, wherein the contra surface is arranged on the movable part.

8. The filling piece coupling assembly according to claim 6, wherein the shutter comprises an engagement surface that is engageable with a transfer element of a filling piece, wherein the shutter is biased in the closed position, to be pushed towards the open position by the transfer element against the bias of the shutter, and wherein the movable part is, in the standard position, biased in a direction opposite to the bias of the shutter.

9. The filling piece coupling assembly according to claim 6, wherein the coupling piece comprises a distinct second internal thread, which is aligned parallel to the first internal thread and spaced therefrom in an axial direction, wherein the second internal thread is configured to cooperate with a second outer thread of a filling piece to releasably connect the filling piece to the coupling piece, to form a gas-tight connection between the coupling piece and an inflow opening of the filling piece,
wherein the first internal thread and the second internal thread are spaced away from each other such that the second internal thread does not interfere with the movable part in the release position.

10. The filling piece coupling assembly according to claim 6, wherein the transfer element, when the filling piece is releasably connected to the coupling piece, limits the movement of the shutter, when arranged in the closed position, towards the transfer element, such that that movement of the movable part towards the release position also causes movement of the shutter towards the open position due to engagement of the shutter with the transfer element.

11. The filling piece coupling assembly according to claim 1, wherein the inflow opening is arranged at a first end of the hollow body,
wherein the outflow opening is, located sideways with respect to the hollow body,
wherein the transfer element is located in the hollow body and wherein an outer perimeter of the transfer element substantially corresponds to an inner perimeter of the hollow body to be slidably moved inside the hollow body,
wherein the hollow body comprises an actuation opening at a second end, opposite to the first end,
wherein the transfer element partially protrudes out of the hollow body through the actuation opening,
wherein the actuation opening is closed-off by the transfer element,
wherein the actuator further comprises a lever that is pivotable with respect to the hollow body between a free position and an actuated position,
wherein the lever comprises a contact surface configured to engage with the part of the transfer element that protrudes through the actuation opening to,
wherein the lever is, upon movement from the free position to the actuated position, configured to push the transfer element to move the shutter to the open position, in particular against a gas pressure in the gas tank, and
wherein the outflow opening is located in between the first end and the second end of the hollow body.

12. (canceled)

13. (canceled)

14. (canceled)

15. The filling piece coupling assembly according to claim 1, wherein the filling piece further comprises a nozzle, for example for inflating balloons, which is attached to the hollow body at the outflow opening thereof.

16. The filling piece coupling assembly according to claim 1, wherein the filling piece comprises a filling piece biasing element to bias the transfer element away from the inflow opening, e.g. away from the shutter.

17. (canceled)

18. The filling piece coupling assembly according to claim 1, wherein the first internal thread and the second internal thread are coaxially aligned with each other.

19. The filling piece coupling assembly according to claim 1, wherein an inner diameter of the first internal thread is smaller than an inner diameter of the second internal thread.

20. A gas tank, comprising the filling piece coupling assembly according to claim 1.

21. (canceled)

22. (canceled)

23. The gas tank according to claim 20, wherein the valve forms the only pressure relief device and/or wherein the safe rated pressure of the valve is less than a safe rated pressure of a burst disc pressure relief device of the gas tank.

24. A method for providing overpressure protection to a gas tank, comprising the steps of:
providing the gas tank according to claim 20,
connecting the valve to the coupling piece by means of the first internal thread and the first outer thread, and
connecting the filling piece to the coupling piece by means of the second internal thread and the second outer thread.

25. A method for coupling a filling piece and a valve to a coupling piece, comprising the steps of:
providing the filling piece coupling assembly according to claim 1,
connecting the valve to the coupling piece by means of the first internal thread and the first outer thread, and
connecting the filling piece to the coupling piece by means of the second internal thread and the second outer thread, by rotating a mounting ring of the filling piece, provided with the second outer thread, with respect to the coupling piece, whilst holding the hollow body of the filling piece stationary.

26. A method for refilling a gas tank comprising the steps of:
providing the gas tank according to claim 20,
disconnecting, if present, the filling piece from the coupling piece by releasing the threaded connection between the second internal thread and the second outer thread,
filling the gas tank through the valve, and
connecting the filling piece to the coupling piece by means of the second internal thread and the second outer thread.
